(19) United States
(12) Patent Application Publication
(10) Pub. No.: US 2020/0074564 A1
(43) Pub. Date: Mar. 5, 2020

(54) SYSTEM AND METHOD FOR FACILITATING AND MANAGING TRANSACTIONS OF FRACTIONAL OWNERSHIP INTERESTS IN ASSETS

(71) Applicant: Merritt Exchange LLC, Memphis, TN (US)

(72) Inventor: Frederick L. Merritt, JR., Memphis, TN (US)

(21) Appl. No.: 16/677,181

(22) Filed: Nov. 7, 2019

Related U.S. Application Data
(63) Continuation of application No. 15/297,286, filed on Oct. 19, 2016.
(60) Provisional application No. 62/244,890, filed on Oct. 22, 2015.
(60) Provisional application No. 62/278,768, filed on Jan. 14, 2016.

(51) Int. Cl. G06Q 40/00; G06F 16/23

(52) U.S. Cl. CPC G06Q 40/12; G06F 16/23

(57) ABSTRACT

In a system and method for facilitating and managing transactions of fractional ownership interests in assets, one or more assets are stored in an asset repository. An asset database is in communication with a central computer server and maintains records of each of the one or more assets in the asset repository. There are multiple user devices, each of which communicates with the central computer server via a software application running on the user device. A transaction is initiated via the software application running on a selected user device with respect to a fractional ownership interest in a selected asset. The transaction is communicated from the selected user device to the central computer server, and the central computer server confirms the transaction and then updates the asset database to reflect a change of ownership of the selected asset.

### CROSS-REFERENCE TO RELATED APPLICATIONS

The present application is a continuation of U.S. patent application Ser. No. 15/297,286 filed on Oct. 19, 2016, which claims priority to U.S. Patent Application Ser. No. 62/244,890 filed on Oct. 22, 2015 and U.S. Patent Application Ser. No. 62/278,768 filed on Jan. 14, 2016. Each of these priority applications is incorporated herein by reference.

### BACKGROUND OF THE INVENTION

The present invention relates to transactions of fractional ownership interests in assets.

In many cases, because of the cost of a particular asset or the limited resources of an individual consumer, certain assets can never be acquired or owned by the individual consumer. Such assets may include commodities, such as gold, silver, copper, platinum, palladium, and other precious metals. Such assets may also include a wide variety of other tangible items, such as antiques, collectibles, gems, currency, bearer bonds, treasury bills, canned goods, ammunition, dried goods, or other tangible assets that are durable and fungible. Accordingly, it would be desirable to establish a system and method for sharing ownership of identified assets, and for facilitating and managing transactions of fractional ownership interests in those assets, including buying, selling, or trading of the fractional ownership interests.

### SUMMARY OF THE INVENTION

The present invention is a system and method for facilitating and managing transactions of fractional ownership interests in assets.

In an exemplary implementation of the system and method for facilitating and managing transactions of fractional ownership interest in assets, multiple users are in communication with a central computer server and associated asset database. Such communications are preferably facilitated through an Internet connection, satellite communications, other communications network, or similar known means of data transport. Specifically, such users are preferably in communication with the central computer server through a software program that communicates with the central computer server, preferably in the form of an application which is run on a smartphone, tablet, desktop computer, or other computing device with a microprocessor, an internal memory component (e.g., a hard drive or solid-state drive), and a display screen. Alternatively, the software program that communicates with the central computer server may be a web-based application accessible through a common Internet browser. Each user preferably has an account, and all relevant information about the users, including, for example, login credentials, is stored in a user database.

The asset database maintains all records of each asset. The record of each asset may include, but is not limited to, the following information: an identification of the asset; a description of the asset; a current value of the asset; a value of available fractional ownership interests in the asset; a photograph or other imagery of the asset; and a current location of the asset. With respect to the current location of the asset, the asset could be stored with other assets in an asset repository, or it could be stored at another verified asset location, and that location information is communicated back to the server and stored in the asset database.

Once an asset has been identified, and a record has been created in the asset database with the requisite information, fractional ownership interests (or units) in that asset can then be bought, sold, or traded through use of the above-mentioned application. Thus, the system and method of the present invention establishes a marketplace for the buying, selling, and trading of fractional ownership interests (or units) in assets, a system and method which allows for a user to make asset-based electronic investments and payments quickly and simply.

Furthermore, with respect to the buying, selling, or trading of fractional ownership interests (or units), through the central computer server and the associated asset database and user database, transactions between multiple parties can also be facilitated. As an additional refinement, it should also be recognized that an “asset” is not limited to a single item. For instance, multiple assets could be bundled into a composite asset, and then, fractional ownership interests (or units) of the composite asset could also be bought, sold, or traded.

### DESCRIPTION OF THE DRAWINGS

FIG. 1 is a schematic illustration of an exemplary implementation of the system and method of the present invention;

FIG. 2 is a representative display screen in a mobile app that illustrates the home screen in an exemplary implementation of the system and method of the present invention;

FIG. 3 is a representative display screen in a mobile app that illustrates, in part, a buy transaction in an exemplary implementation of the system and method of the present invention;

FIG. 4 is a representative display screen in a mobile app that illustrates a list of available assets in an exemplary implementation of the system and method of the present invention;

FIG. 5 is a representative display screen in a mobile app that illustrates details of a particular available asset in an exemplary implementation of the system and method of the present invention;

FIG. 6 is a representative display screen in a mobile app that illustrates, in part, a buy transaction in an exemplary implementation of the system and method of the present invention;

FIGS. 7-8 are representative display screens in a mobile app that illustrate a sell transaction in an exemplary implementation of the system and method of the present invention;

FIGS. 9-10 are representative display screens in a mobile app that illustrate a transfer transaction in an exemplary implementation of the system and method of the present invention;

FIGS. 11-12 are representative display screens in a mobile app that illustrate a trade transaction in an exemplary implementation of the system and method of the present invention;

FIGS. 13-15 are representative display screens in a mobile app that illustrate a transfer transaction in an exemplary implementation of the system and method of the present invention;

and

FIGS. 16-17 are representative display screens in a mobile app that illustrate a redeem transaction in an exemplary implementation of the system and method of the present invention.

### DETAILED DESCRIPTION OF THE INVENTION

In a system and method for facilitating and managing transactions of fractional ownership interests in assets in accordance with the present invention, a record of each asset is created and stored in an asset database associated with a central computer server. Multiple users can access the record of the asset through a software program that is in communication with the central computer server. In most cases, each individual user would have access to the record of any asset in which he has a fractional ownership interest (as further discussed below) or the record of any asset listed for sale. Then, via the software program, a user can buy, sell, or trade a fractional ownership interest in the asset, and the record as stored in the database is then updated to reflect any such transactions.

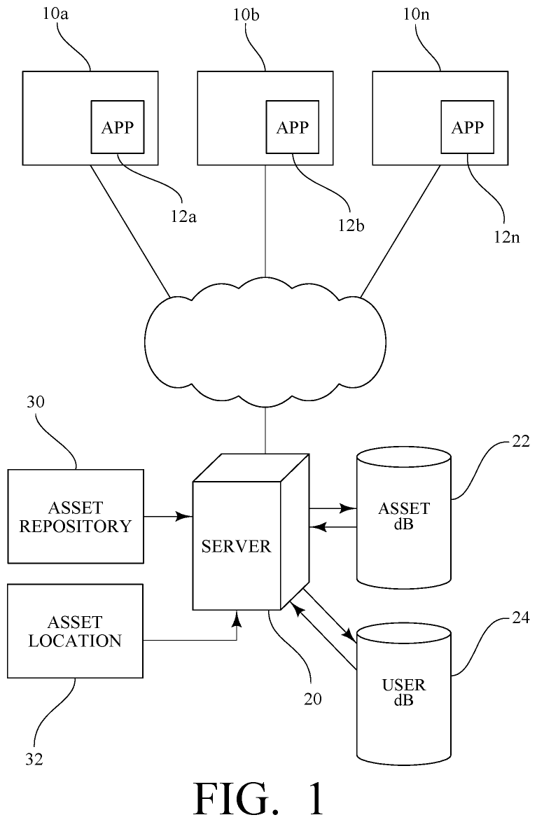

Referring now to FIG. 1, in an exemplary implementation of the system and method for facilitating and managing transactions of fractional ownership interest in assets, multiple users 10a, 10b, . . . 10n are in communication with a central computer server 20 and associated asset database 22. Such communications are preferably facilitated through an Internet connection, satellite communications, other communications network, or similar known means of data transport. Specifically, such users 10a, 10b, . . . 10n are preferably in communication with the central computer server 20 through a software program 12a, 12b, . . . 12n that communicates with the central computer server 20, preferably in the form of an application (or “app”) which is run on a smartphone, tablet, desktop computer, or other computing device (i.e., a “user device”) with a microprocessor, an internal memory component (e.g., a hard drive or solid-state drive), and a display screen. Alternatively, the software program 12a, 12b, . . . 12n that communicates with the central computer server 20 may be a web-based application accessible through a common Internet browser. Each user 10a, 10b, . . . 10n preferably has an account, and all relevant information about the users 10a, 10b, . . . 10n, including, for example, login credentials, is stored in a user database 24.

Referring still to FIG. 1, the asset database 22 maintains all records of each asset. The record of each asset may include, but is not limited to, the following information: an identification of the asset; a description of the asset; a current value of the asset; a value of available fractional ownership interests in the asset; a photograph or other imagery of the asset; and a current location of the asset. With respect to the current location of the asset, as shown in FIG. 1, the asset could be stored with other assets in an asset repository 30, or it could be stored at another verified asset location 32, and that location information is communicated back to the central computer server 20 and stored in the asset database 22.

Once an asset has been identified, and a record has been created in the asset database 22 with the requisite information, fractional ownership interests (or units) in that asset can then be bought, sold, or traded through use of the above-mentioned app by the users 10a, 10b, . . . 10n.

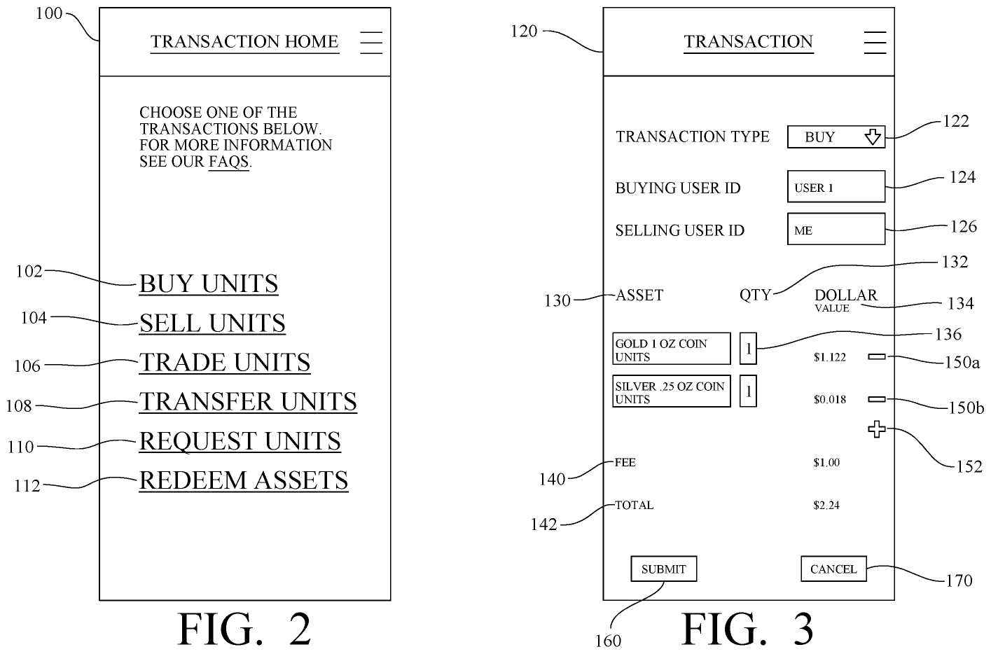

For example, FIG. 2 is a representative display screen 100 in a mobile app that illustrates a home screen in an exemplary implementation of the system and method of the present invention. As shown, from this home screen, the user can make an appropriate selection to execute multiple types of transactions, including: (i) a buy transaction, as represented by a hyperlink or virtual button labeled “Buy Units” and indicated by reference numeral 102; (ii) a sell transaction, as represented by a hyperlink or virtual button labeled “Sell Units” and indicated by reference numeral 104; (iii) a trade transaction, as represented by a hyperlink or virtual button labeled “Trade Units” and indicated by reference numeral 106; (iv) a transfer transaction, as represented by a hyperlink or virtual button labeled “Transfer Units” and indicated by reference numeral 108; (v) a request transaction, as represented by a hyperlink or virtual button labeled “Request Units” and indicated by reference numeral 110; and (vi) a redeem assets transaction, as represented by a hyperlink or virtual button labeled “Redeem Units” and indicated by reference numeral 112. Each of these transactions will be discussed in further detail below. Of course, the home screen may also present other options, menus, etc., as is typical with any software program or application running on a smartphone, tablet, desktop computer, or other computing device.

FIG. 3 is a representative display screen 120 in a mobile app that illustrates, in part, a buy transaction. As shown, the display screen 120 includes a field 122 that is labeled “Transaction Type” and confirms that a buy transaction has been selected. This field 122 may further be provided with a pull-down menu that allows a user to select a different type of transaction. The display screen 120 also includes a field 124 that is labeled “Buying User ID” to identify the buyer, which, in this case, is User 1, i.e., the user that is logged in and is using the app. The display screen 120 also includes a field 126 that is labeled “Selling User ID” to identify the seller; however, it is contemplated that, in many cases, the seller would be the operator of the marketplace or a vendor authorized by the operator of the marketplace, which is represented my “ME” in this example.

In this example, User 1 is purchasing one fractional ownership interest (or unit) in a 1-oz. gold coin at a cost of $1.122 and one fractional ownership interest (or unit) in a 0.25-oz. silver coin at a cost of $0.018. In this example, a unit is equivalent to a 1/1000 fractional ownership interest, but unit values could also be representative of other fractional interests without departing from the spirit and scope of the present invention. As shown, in this exemplary implementation, information about the fractional ownership interest (or unit) of the items that are being purchased is presented in a tabular format in columns labeled “Asset” 130, “Qty” 132, and “Dollar Value” 134. Furthermore, although the identification of the asset in the first column (“Asset”) is fixed and the dollar value (“Dollar Value”) in the last column is calculated, it is preferred that the number presented in the middle column (“Qty”) can be updated by the user to reflect a desired quantity. In other words, there is a field 136 into which quantity data can be entered in the middle column (“Qty”). Lastly, in this exemplary implementation, as also shown, the display screen 120 displays a fee 140 and a total transaction amount 142, $1.00 and $2.24, respectively.

In this exemplary implementation, as shown, there are minus sign icons 150a, 150b next to each of fractional ownership interests (or units) that are being purchased. By clicking on or otherwise selecting one of the minus sign icons 150a, 150b, that item is removed from the buy transaction. Similarly, there is also a plus sign icon 152. By clicking on or otherwise selecting the plus sign icon 152, a new item can be added to the buy transaction, as further discussed below.

In this exemplary implementation, as shown, there is also a “Submit” button 160. When the user selects the “Submit” button 160, that action is communicated to the central computer server 20 (FIG. 1), which confirms the buy transaction, and the record of the asset(s) associated with the buy transaction as stored in the asset database 22 (FIG. 1) is updated, in this example, to indicate that User 1 now owns one fractional ownership interest (or unit) in a 1-oz. gold coin and one fractional ownership interest (or unit) in a 0.25-oz. silver coin. At the same time, the information stored in the user database 24 (FIG. 1) about User 1 may also be updated.

In this exemplary implementation, as shown, there is also a “Cancel” button 170, selection of which cancels the buy transaction.

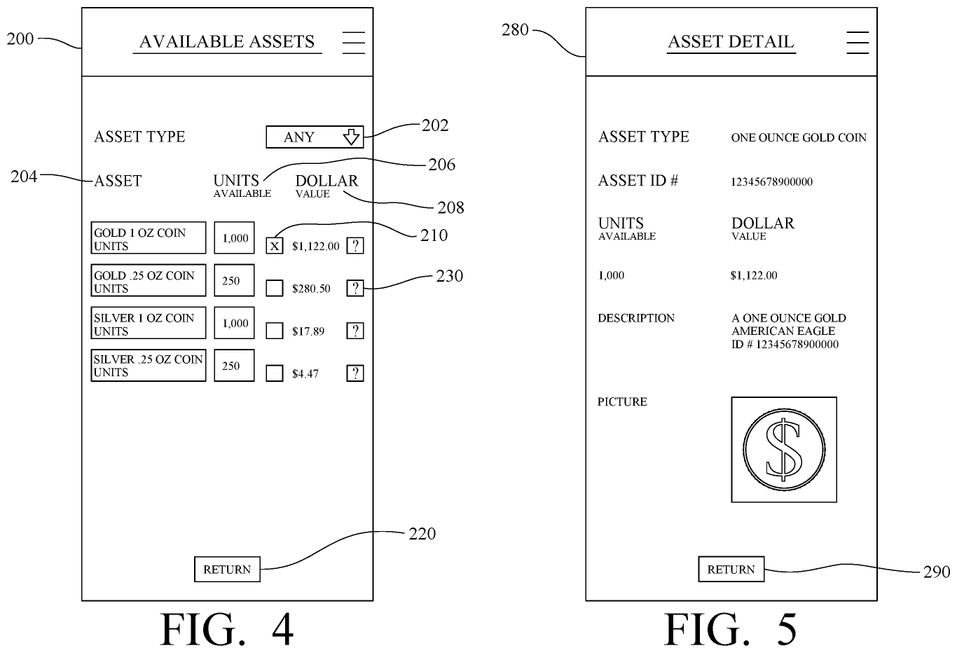

As mentioned above, in the representative display screen 120 for the buy transaction (FIG. 3), there is a plus sign icon 152 for adding a new item to the buy transaction. When that plus sign icon 152 is clicked on or otherwise selected, a list of available assets is displayed. FIG. 4 is a representative display screen 200 in a mobile app that illustrates an example list of assets. As shown, the display screen 200 includes a pull-down menu 202 that allows a user to filter the types of assets that are displayed. Then, the list of available assets is displayed. As shown, in this exemplary implementation, the list of available assets is presented in a tabular format in columns labeled “Asset” 204, “Units Available” 206, and “Dollar Value” 208. Checking a box 210 or otherwise selecting one or more of the available assets indicates that the asset is to be added to the buy transaction. Then, in this exemplary implementation, as shown, there is a “Return” button 220, selection of which adds the selected assets to the buy transaction, returning the user to the display screen 120 of FIG. 3.

Referring again to FIG. 4, in this exemplary implementation, as shown, there is a question mark icon 230 next to each of the one or more of the available assets. By selecting the question mark icon 230 next to a particular available asset, the user is directed to information about the available asset. For example, FIG. 5 is another representative display screen 280 in a mobile app, which, in this example, includes information such as asset type, an asset identification number, a number of units available, a current (dollar) value of the asset, a description (or identification) of the asset; and a photograph or other imagery of the asset. Of course, any information in the record of the asset as stored in the asset database 22 could be retrieved and displayed here. In this exemplary implementation, as shown, there is a “Return” button 290, selection of which returns the user to the display screen 200 of FIG. 4.

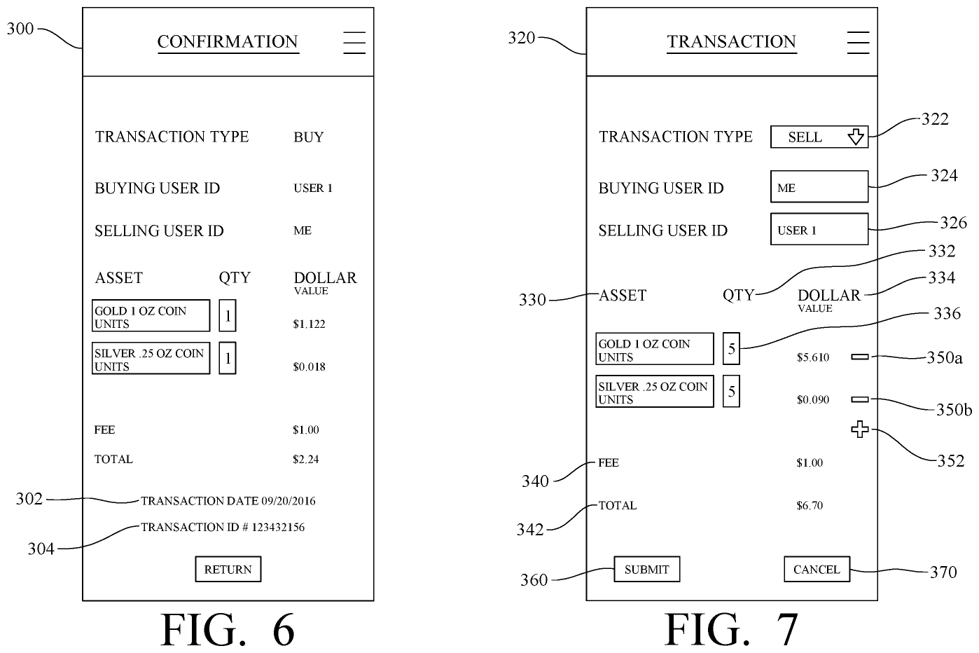

FIG. 6 is a representative display screen 300 in a mobile app that illustrates a confirmation of a buy transaction, which is displayed to the user once the user selects the “Submit” button 160 in the display screen 120 (FIG. 3) and the buy transaction has been confirmed by the central computer server 20 (FIG. 1). In this exemplary implementation, as shown, the display screen 300 includes much of the same information as included on the display screen 120 (FIG. 3), but since it is displaying a confirmation of the buy transaction, it also includes data fields labeled “Transaction Date” 302 and “Transaction ID #” 304.

FIG. 7 is a representative display screen 320 in a mobile app that illustrates, in part, a sell transaction. As shown, the display screen 320 includes a field 322 that is labeled “Transaction Type” and confirms that a sell transaction has been selected. This field 322 may further be provided with a pull-down menu that allows a user to select a different type of transaction. The display screen 320 also includes a field 324 that is labeled “Buying User ID” to identify the buyer, which, in this case, is the operator of the marketplace, which is represented my “ME” in this example. The display screen 320 also includes a field 326 that is labeled “Selling User ID” to identify the seller, which, in this case, is User 1, i.e., the user that is logged in and is using the app.

In this example, User 1 is selling five (5) fractional ownership interests (or units) in a 1-oz. gold coin at a cost of $5.610 and five (5) fractional ownership interests (or units) in a 0.25-oz. silver coin at a cost of $0.090. Similar to the buy transaction described above, in this example, a unit is equivalent to a 1/1000 fractional ownership interest, but unit values could also be representative of other fractional interests without departing from the spirit and scope of the present invention. As shown, in this exemplary implementation, information about the fractional ownership interests (or units) of the items that are being sold is presented in a tabular format in columns labeled “Asset” 330, “Qty” 332, and “Dollar Value” 334. Furthermore, although the identification of the asset in the first column (“Asset”) is fixed and the dollar value (“Dollar Value”) in the last column is calculated, it is preferred that the number presented in the middle column (“Qty”) can be updated by the user to reflect a desired quantity. In other words, there is a field 336 into which quantity data can be entered in the middle column (“Qty”). Lastly, in this exemplary implementation, as also shown, the display screen 320 displays a fee 340 and a total transaction amount 342, $1.00 and $6.70, respectively.

In this exemplary implementation, as shown, there are minus sign icons 350a, 350b next to each of fractional ownership interests (or units) that are being purchased. By clicking on or otherwise selecting one of the minus sign icons 350a, 350b, that item is removed from the sell transaction. Similarly, there is also a plus sign icon 352. By clicking on or otherwise selecting the plus sign icon 352, a new item can be added to the sell transaction in a similar manner to the way in which an item is added to a buy transaction, as described above with reference to FIG. 4.

Referring still to FIG. 7, in this exemplary implementation, as shown, there is also a “Submit” button 360. When a user selects the “Submit” button 360, that action is communicated to the central computer server 20 (FIG. 1), which confirms the sell transaction, and the record of the asset(s) associated with the sell transaction as stored in the asset database 22 (FIG. 1) is updated, in this example, to indicate that User 1 has sold five (5) fractional ownership interests (or units) in a 1-oz. gold coin and five (5) fractional ownership interests (or units) in a 0.25-oz. silver coin. At the same time, the information stored in the user database 24 (FIG. 1) about User 1 may also be updated.

In this exemplary implementation, as shown, there is also a “Cancel” button 370, selection of which cancels the sell transaction.

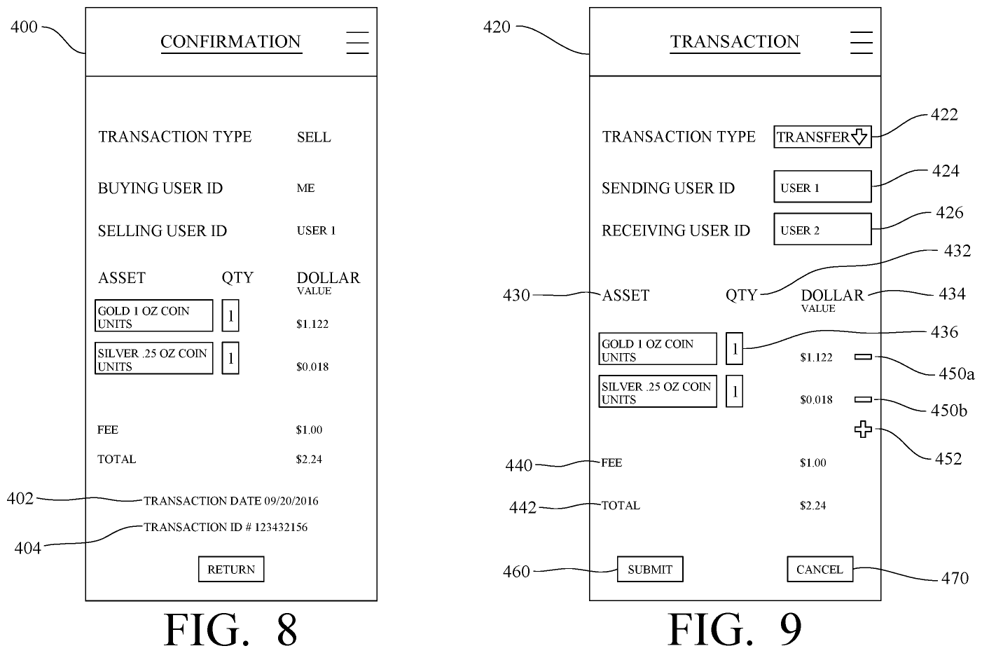

FIG. 8 is a representative display screen 400 in a mobile app that illustrates a confirmation of a sell transaction, which is displayed to the user once the user selects the “Submit” button 360 in the display screen 320 (FIG. 7) and the sell transaction has been confirmed by the central computer server 20 (FIG. 1). In this exemplary implementation, as shown, the display screen 400 includes much of the same information as included on the display screen 320 (FIG. 7), but since it is displaying a confirmation of the sell transaction, it also includes data fields labeled “Transaction Date” 402 and “Transaction ID #” 404.

FIG. 9 is a representative display screen 420 in a mobile app that illustrates, in part, a transfer transaction. As shown, the display screen 420 includes a field 422 that is labeled “Transaction Type” and confirms that a transfer transaction has been selected. This field 422 may further be provided with a pull-down menu that allows a user to select a different type of transaction. The display screen 420 also includes a field 424 that is labeled “Sending User ID” to identify the party which is transferring (or sending) the fractional ownership interests (or units), which, in this case, is User 1, i.e., the user that is logged in and is using the app. The display screen 420 also includes a field 426 that is labeled “Receiving User ID” to identify the recipient, which, in this case, is User 2.

In this example, User 1 is transferring one fractional ownership interest (or unit) in a 1-oz. gold coin at a cost of $1.122 and one fractional ownership interest (or unit) in a 0.25-oz. silver coin at a cost of $0.018. As shown, in this exemplary implementation and similar to the buy and sell transactions described above, information about the fractional ownership interest (or unit) of the items that are being purchased is presented in a tabular format in columns labeled “Asset” 430, “Qty” 432, and “Dollar Value” 434. Furthermore, similar to the buy and sell transactions described above, there is a field 436 into which quantity data can be entered in the middle column (“Qty”), and the display screen 420 also displays a fee 440 and a total transaction amount 442, $1.00 and $2.24, respectively.

As shown, in this exemplary implementation and similar to the buy and sell transactions described above, there are minus sign icons 450a, 450b next to each of fractional ownership interests (or units) that are being purchased. By clicking on or otherwise selecting one of the minus sign icons 450a, 450b, that item is removed from the transfer transaction. Similarly, there is also a plus sign icon 452. By clicking on or otherwise selecting the plus sign icon 452, a new item can be added to the transfer transaction in a similar manner to the way in which an item is added to a buy or sell transaction, as described above.

Referring still to FIG. 9, in this exemplary implementation, as shown, there is also a “Submit” button 460. When the user selects the “Submit” button 460, that action is communicated to the central computer server 20 (FIG. 1), which confirms the transfer transaction, and the record of the asset(s) associated with the transfer transaction as stored in the asset database 22 (FIG. 1) is updated, in this example, to indicate that User 1 has transferred ownership of one fractional ownership interest (or unit) in a 1-oz. gold coin and one fractional ownership interest (or unit) in a 0.25-oz. silver coin to User 2. At the same time, the information stored in the user database 24 (FIG. 1) about User 1 and User 2 may also be updated.

In this exemplary implementation, as shown, there is also a “Cancel” button 470, selection of which cancels the transfer transaction.

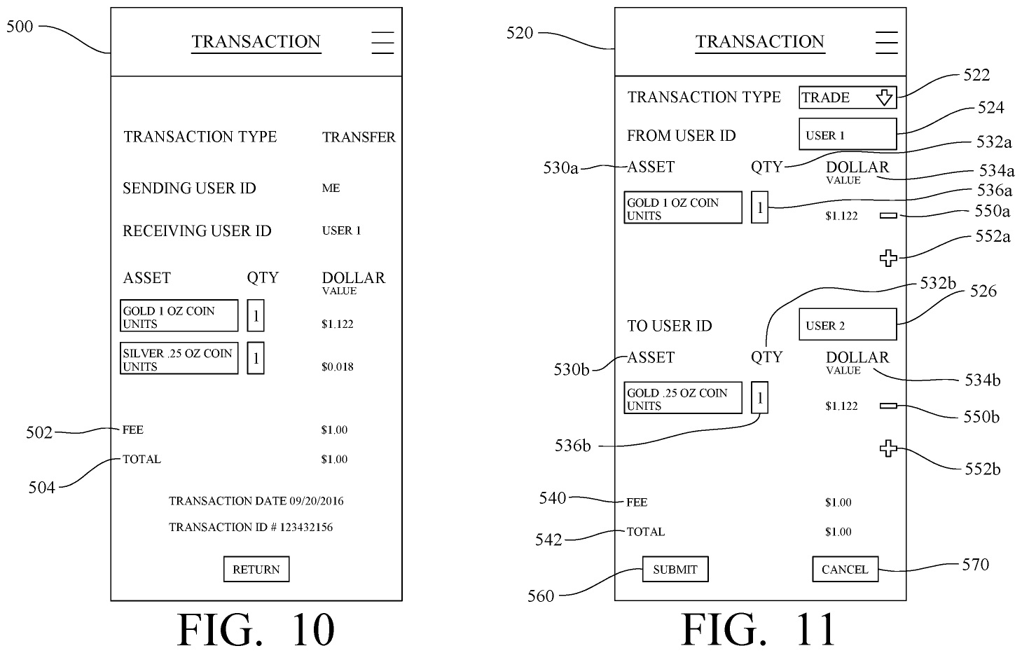

FIG. 10 is a representative display screen 500 in a mobile app that illustrates a confirmation of a transfer transaction, which is displayed to the user once the user selects the “Submit” button 460 in the display screen 420 (FIG. 9) and the transfer transaction has been confirmed by the central computer server 20 (FIG. 1). In this exemplary implementation, as shown, the display screen 500 includes much of the same information as included on the display screen 420 (FIG. 9), but since it is displaying a confirmation of the transfer transaction, it also includes data fields labeled “Transaction Date” 502 and “Transaction ID #” 504.

FIG. 11 is a representative display screen 520 in a mobile app that illustrates, in part, a trade transaction. As shown, the display screen 520 includes a field 522 that is labeled “Transaction Type” and confirms that a trade transaction has been selected. This field 522 may further be provided with a pull-down menu that allows a user to select a different type of transaction. The display screen 520 also includes a field 524 that is labeled “From User ID,” which, in this case, is User 1, i.e., the user that is logged in and is using the app. The display screen 520 also includes a field 526 that is labeled “To User ID,” which, in this case, is User 2.

In this example, User 1 is trading one fractional ownership interest (or unit) in a 1-oz. gold coin at a cost of $1.122 to User 2, in exchange for four (4) fractional ownership interests (or units) in a 0.25-oz. gold coin at an equivalent cost of $1.122. As shown, in this exemplary implementation and similar to the buy and sell transactions described above, information about the fractional ownership interest (or unit) of the items that are being traded is presented in a tabular format in columns labeled “Asset” 530a, 530b, “Qty” 532a, 532b, and “Dollar Value” 534a, 534b, but in this case, there are two tables, one associated with each user participating in the trade transaction. Furthermore, similar to the buy and sell transactions described above, in each table, there is a field 536a, 536b into which quantity data can be entered in the middle column (“Qty”), and the display screen 520 also displays a fee 540 and a total transaction amount 542, $1.00 and $1.00 (since it is an even trade), respectively.

As shown, in this exemplary implementation and similar to the buy and sell transactions described above, there are minus sign icons 550a, 550b next to each of fractional ownership interests (or units) that are being traded. By clicking on or otherwise selecting one of the minus sign icons 550a, 550b, that item is removed from the trade transaction. Similarly, there are also plus sign icons 552a, 552b for each user. By clicking on or otherwise selecting a plus sign icon 552a, 552b, a new item can be added to the trade transaction in a similar manner to the way in which an item is added to a buy or sell transaction, as described above.

Referring still to FIG. 11, in this exemplary implementation, as shown, there is also a “Submit” button 560, selection of which initiates the trade transaction. In this case, since this is a trade transaction, the other user (User 2) must approve the trade transaction proposed by the first user (User 1). Thus, by selecting the “Submit” button 560, a notification is sent via the central computer server 20 (FIG. 1) to the other user (User 2) to request approval of the trade transaction. Once the other user (User 2) approves the trade transaction, as confirmed by the central computer server 20 (FIG. 1), the record of the asset(s) associated with the trade transaction as stored in the asset database 22 (FIG. 1) is updated, in this example, to indicate that User 1 has traded ownership of one fractional ownership interest (or unit) in a 1-oz. gold coin at a cost of $1.122 to User 2, in exchange for four (4) fractional ownership interests (or units) in a 0.25-oz. gold coin. At the same time, the information stored in the user database 24 (FIG. 1) about User 1 and User 2 may also be updated.

In this exemplary implementation, as shown, there is also a “Cancel” button 570, selection of which cancels the trade transaction.

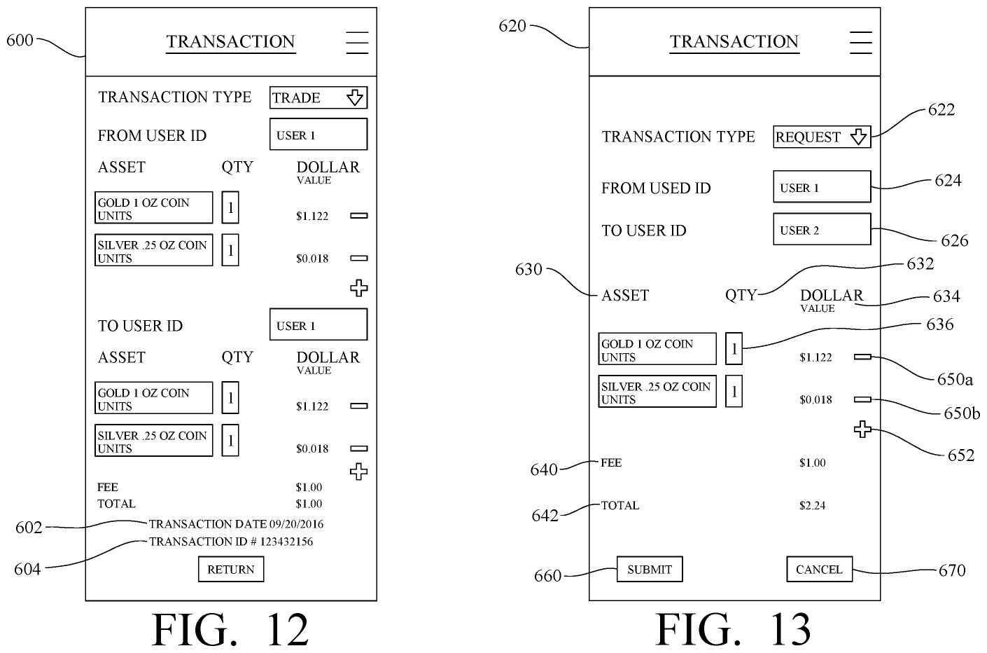

FIG. 12 is a representative display screen 600 in a mobile app that illustrates a confirmation of a trade transaction, which is displayed to the user once the user selects the “Submit” button 560 in the display screen 520 (FIG. 11) and the trade transaction has been confirmed by the central computer server 20 (FIG. 1). In this exemplary implementation, as shown, the display screen 600 includes much of the same information as included on the display screen 520 (FIG. 11), but since it is displaying a confirmation of the trade transaction, it also includes data fields labeled “Transaction Date” 602 and “Transaction ID #” 604.

FIG. 13 is a representative display screen 620 in a mobile app that illustrates, in part, a request transaction. As shown, the display screen 620 includes a field 622 that is labeled “Transaction Type” and confirms that a request transaction has been selected. This field 622 may further be provided with a pull-down menu that allows a user to select a different type of transaction. The display screen 620 also includes a field 624 that is labeled “From User ID,” which, in this case, is User 1, i.e., the user that is logged in and is using the app. The display screen 620 also includes a field 626 that is labeled “To User ID,” which, in this case, is User 2. In this request transaction, User 1 is essentially requesting that User 2 sell him certain fractional ownership interests (or units) in identified assets.

In this example, User 1 is requesting one fractional ownership interest (or unit) in a 1-oz. gold coin at a cost of $1.122 and one fractional ownership interest (or unit) in a 0.25-oz. silver coin at a cost of $0.018 from User 2. As shown, in this exemplary implementation and similar to the buy and sell transactions described above, information about the fractional ownership interest (or unit) of the items that are being purchased is presented in a tabular format in columns labeled “Asset” 630, “Qty” 632, and “Dollar Value” 634. Furthermore, similar to the buy and sell transactions described above, there is a field 636 into which quantity data can be entered in the middle column (“Qty”), and the display screen 620 also displays a fee 640 and a total transaction amount 642, $1.00 and $2.24, respectively.

As shown, in this exemplary implementation and similar to the buy and sell transactions described above, there are minus sign icons 650a, 650b next to each of fractional ownership interests (or units) that are the subject of the proposed request transaction. By clicking on or otherwise selecting one of the minus sign icons 650a, 650b, that item is removed from the request transaction. Similarly, there is also a plus sign icon 652. By clicking on or otherwise selecting the plus sign icon 652, a new item can be added to the request transaction in a similar manner to the way in which an item is added to a buy or sell transaction, as described above.

Referring still to FIG. 13, in this exemplary implementation, as shown, there is also a “Submit” button 660, selection of which initiates the request transaction. Of course, to complete the transfer transaction, the other user (User 2) must approve the request transaction proposed by the first user (User 1). Thus, by selecting the “Submit” button 660, a notification is sent to the other user (User 2) via the central computer server 20 (FIG. 1) to request approval of the request transaction.

In this exemplary implementation, as shown, there is also a “Cancel” button 670, selection of which cancels the request transaction.

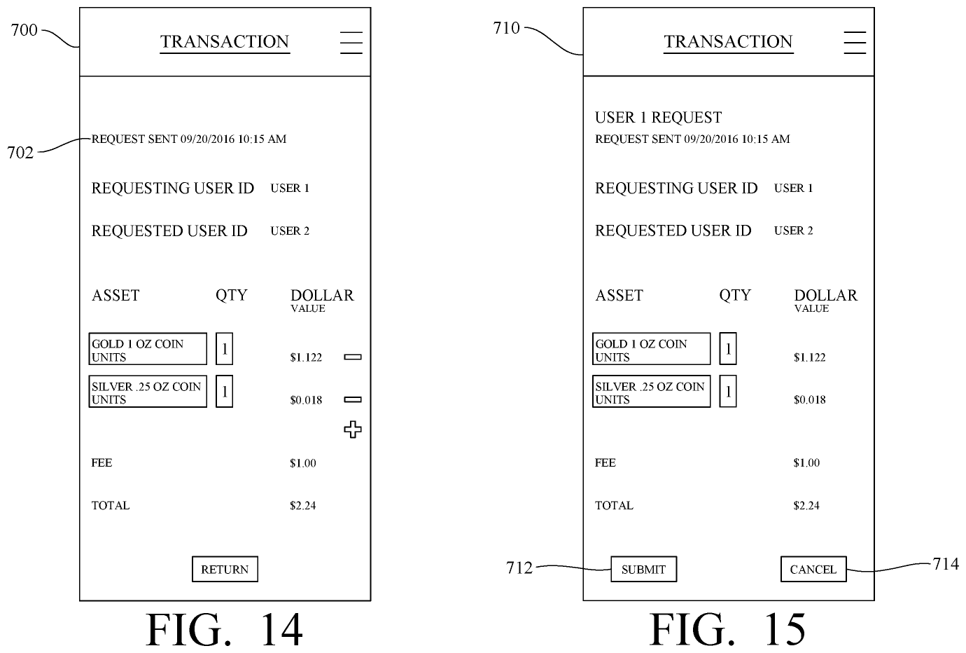

FIG. 14 is a representative display screen 700 in a mobile app that illustrates a confirmation that the request transaction has been initiated, which is displayed to the user (User 1) once the user selects the “Submit” button 660 in the display screen 620 (FIG. 13). In this exemplary implementation, as shown, the display screen 700 includes much of the same information as included on the display screen 620 (FIG. 13), but since it is displaying a confirmation that the request transaction has been initiated, it also includes a data field labeled “Request Sent” 702.

FIG. 15 is a representative display screen 710 in a mobile app that illustrates a request sent to User 2 to accept a request transaction, i.e., that User 2 sell certain fractional ownership interests (or units) in identified assets to User 1. In this exemplary implementation, as shown, the display screen 710 includes much of the same information as included on the display screen 620 (FIG. 11), and then includes a “Submit” button 712, selection of which approves the request transaction. Specifically, by selecting the “Submit” button 712, User 2 completes the request transaction, which is confirmed by the central computer server 20 (FIG. 1), and the record of the asset(s) associated with the request transaction as stored in the asset database 22 is updated, in this example, to indicate that User 2 has transferred ownership of one fractional ownership interest (or unit) in a 1-oz. gold coin and one fractional ownership interest (or unit) in a 0.25-oz. silver coin to User 1. At the same time, the information stored in the user database 24 about User 1 and User 2 may also be updated.

In this exemplary implementation, as shown, there is also a “Cancel” button 714, selection of which cancels (or declines) the request transaction.

FIG. 16 is a representative display screen 720 in a mobile app that illustrates, in part, a redeem transaction. As shown, the display screen 720 includes a field 722 that is labeled “Transaction Type” and confirms that a redeem transaction has been selected. This field 722 may further be provided with a pull-down menu that allows a user to select a different type of transaction. The display screen 720 also includes a field 724 that is labeled “From User ID” to identify the party which is redeeming certain fractional ownership interests (or units), which, in this case, is User 1, i.e., the user that is logged in and is using the app. In this redeem transaction, User 1 is essentially requesting that an asset, in which User 1 owns all fractional ownership interests (or units), be transferred from the asset repository 30 or other verified asset location 32 to him.

In this example, User 1 is requesting redemption of a 1-oz. gold coin at a cost of $1,122.00. As shown, in this exemplary implementation and similar to the buy and sell transactions described above, information about the asset that is being redeemed is presented in a tabular format in columns labeled “Asset” 730, “Qty” 732 (which confirms that User 1 owns all units of the asset), and “Dollar Value” 734. The display screen 720 also displays a fee 740, a shipping and handling fee 741, and a total transaction amount 742. The display screen 720 also displays a shipping address 743 (which has preferably been retrieved from the information stored about User 1 in the user database 24) and an estimated arrival date 744.

Referring still to FIG. 16, in this exemplary implementation, as shown, there is also a “Submit” button 760. When the user selects the “Submit” button 760, that action is communicated to the central computer server 20 (FIG. 1), which confirms the redeem transaction, and the record of the asset(s) associated with the redeem transaction as stored in the asset database 22 (FIG. 1) is updated, in this example, to indicate that fractional ownership interests (or units) in the 1-oz. gold coin are no longer available. At the same time, the information stored in the user database 24 (FIG. 1) about User 1 may also be updated, and the operator of the marketplace ships the asset to User 1.

In this exemplary implementation, as shown, there is also a “Cancel” button 770, selection of which cancels the redeem transaction.

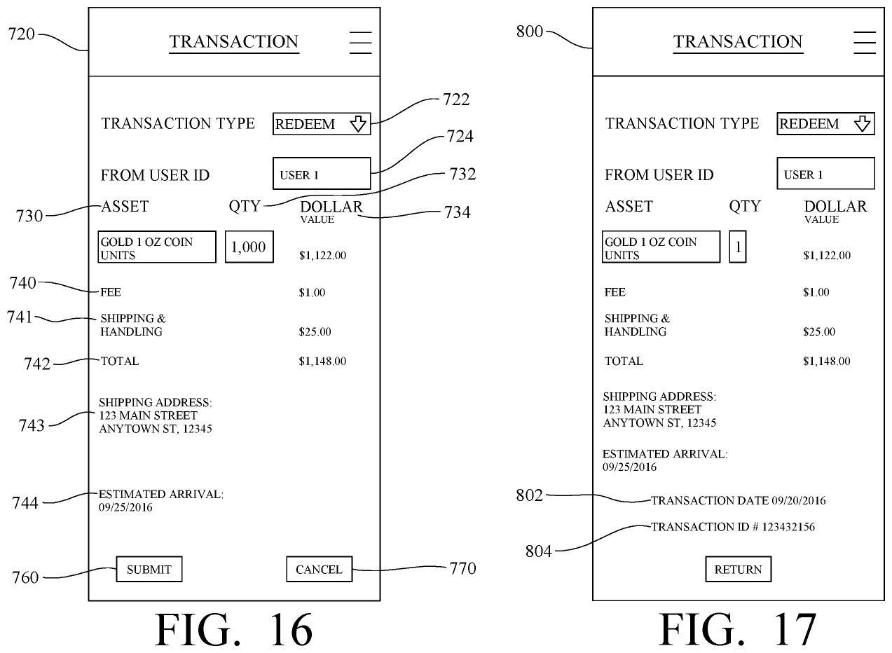

FIG. 17 is a representative display screen 800 in a mobile app that illustrates a confirmation of a redeem transaction, which is displayed to the user once the user selects the “Submit” button 760 in the display screen 720 (FIG. 16) and the redeem transaction has been confirmed by the central computer server 20 (FIG. 1). In this exemplary implementation, as shown, the display screen 800 includes much of the same information as included on the display screen 720 (FIG. 16), but since it is displaying a confirmation of the redeem transaction, it also includes data fields labeled “Transaction Date” 802 and “Transaction ID #” 804.

With respect to the transactions described above, it is contemplated that payment for purchases or other transactions would be facilitated using conventional on-line payment processing tools. For example, registered users may be required to maintain certain funds in their accounts, or the registered users may be able to link their accounts to a credit card, checking or other bank account, or a third-party financial services provider, such as PayPal. All such financial information can be stored in the user database 24 (FIG. 1).

Furthermore, with respect to the buying, selling, or trading of fractional ownership interests (or units), through the central computer server 20 and the associated asset database 22 and user database 24, transactions between multiple parties can also be facilitated. For instance, in one exemplary transaction, Party A owns 100 units of an asset. Party A identifies an item for sale by Party B in an on-line marketplace (such as eBay) for $25.00. Each of the 100 units that the Party A owns is currently worth $1.10. Party A sells 23 units for $25.30 to a third party, Party C, but rather than receiving the cash proceeds, Party A provides instructions that are received and processed by the central computer server 20 to remit $25.00 to Party B directly, returning only $0.30 to Party A.

As an additional refinement, it should also be recognized that an “asset” is not limited to a single item. For instance, the operator of the marketplace could bundle multiple assets into a composite asset, and then, fractional ownership interests (or units) of the composite asset could also be bought, sold, or traded in the manner described above. For example, a composite asset might consist of: one gold coin, one silver coin, a copper bar, and one hundred dollars in currency. Of course, such a composite asset, would represent a diversified bundle of assets, and thus, acquiring fractional ownership interests (or units) of the composite asset may be part of an investment strategy.

The system and method for facilitating and managing transactions of fractional ownership interests in assets of the present invention thus establishes a marketplace for the buying, selling, and trading of fractional ownership interests (or units) in assets, a system and method which allows for user to make asset-based electronic investments and payments quickly and simply.

Finally, with respect to the central computer server, it should be readily apparent to one of ordinary skill in the art that software running on the central computer server causes computer-readable instructions stored in a memory component of the central computer server to be executed by a microprocessor of the central computer server. Similarly, with respect to the app, it should be readily apparent to one of ordinary skill in the art that the app causes computer-readable instructions stored in the memory component of the smartphone, tablet, or other computing device to be executed by the microprocessor of the smartphone, tablet, or other computing device. With respect to the interactions illustrated by the exemplary screen shots, and in view of the foregoing description of the system and method of the present invention, such computer-readable instructions can be readily coded into a computer-readable form using standard programming techniques and languages by one of ordinary skill in the art.

One of ordinary skill in the art will recognize that additional implementations and/or embodiments are also possible without departing from the teachings of the present invention. This detailed description, and particularly the specific details of the exemplary implementation disclosed therein, is given primarily for clarity of understanding, and no unnecessary limitations are to be understood therefrom, for modifications will become obvious to those skilled in the art upon reading this disclosure and may be made without departing from the spirit or scope of the invention.

What is claimed is:

1. A system for facilitating transactions of fractional ownership interests in one or more tangible assets;
an asset repository for storing the one or more tangible assets;
a central computer server;
an asset database in communication with the central computer server, said asset database maintaining records of each of the one or more tangible assets in the asset repository;
multiple user devices, each of the multiple user devices communicating with the central computer server via a software application running on the user device;
wherein, a transaction is initiated via the software application running on a selected user device of the multiple user devices with respect to a fractional ownership interest in a selected asset of the one or more tangible assets, and the transaction is communicated from the selected user device to the central computer server; and
wherein, the central computer server receives and confirms the transaction, and then updates the asset database to reflect a change of ownership of the selected asset.

2. The system as recited in claim 1, wherein the transaction is selected from the group consisting of: a buy transaction; a sell transaction; a trade transaction; a transfer transaction; a request transaction; and a redeem assets transaction.

3. The system as recited in claim 1, and further comprising:
a user database in communication with the central computer server, said user database maintaining records of each of the multiple user devices and associated users, wherein upon receiving and confirming the transaction, the central computer server also updates the user database to reflect the change of ownership of the selected asset.

4. The system as recited in claim 1, wherein each of the one or more tangible assets is a precious metal.

5. A method for facilitating transactions of fractional ownership interests in a tangible asset, comprising the steps of:
creating a record for the tangible asset, including a current location of the tangible asset, and storing the record of the tangible asset in an asset database associated with a central computer server;
providing multiple users with access to the record of the tangible asset through a software program that is in communication with the central computer server; and
upon receiving an instruction from one of the multiple users via the software application, said central computer server updates the record of the tangible asset to reflect a transaction of a fractional ownership interest in the tangible asset by the one of the multiple users.

6. The method as recited in claim 5, wherein the transaction is selected from the group consisting of: a buy transaction; a sell transaction; a trade transaction; a transfer transaction; a request transaction; and a redeem assets transaction.

7. The method as recited in claim 5, wherein the tangible asset is a composite asset of two or more assets.

8. The method as recited in claim 5, wherein a user database maintain records of each of the multiple users, wherein upon receiving the instruction from the one of the multiple users via the software application, said central computer server also updates the user database to reflect the transaction of the fractional ownership interest in the tangible asset by the one of the multiple users.

9. The method as recited in claim 5, wherein the tangible asset is a precious metal.

10. A method in a central computer server for facilitating a transaction of a fractional ownership interest in a tangible asset, comprising the steps of:
receiving, over a communications network, from a user device, an instruction to initiate a transaction with respect to the fractional ownership interest in the tangible asset;
accessing, from an asset database, a record of the tangible asset, including a current location of the tangible asset;
communicating, over the communications network, information from the record of the tangible asset to the user device;
receiving, over the communications network, from the user device, an instruction to execute the transaction with respect to the fractional ownership interest in the tangible asset; and
updating the record of the tangible asset in the asset database the reflect the transaction.

11. The method as recited in claim 10, wherein the transaction is selected from the group consisting of: a buy transaction; a sell transaction; a trade transaction; a transfer transaction; a request transaction; and a redeem assets transaction.

12. The method as recited in claim 10, wherein the tangible asset is a composite asset of two or more assets.

13. The method as recited in claim 10, wherein the tangible asset is a precious metal.
